(19) United States
(12) Patent Application Publication
(10) Pub. No.: US 2013/0013140 A1
(43) Pub. Date: Jan. 10, 2013

(54) METHOD FOR OPERATING A VEHICLE AND VEHICLE

(75) Inventors: Aiko BOEHME, Ingelheim (DE); Heiko BALD, Modautal (DE)

(73) Assignee: GM GLOBAL TECHNOLOGY OPERATIONS LLC, Detroit, MI (US)

(21) Appl. No.: 13/542,773

(22) Filed: Jul. 6, 2012

(30) Foreign Application Priority Data
Jul. 8, 2011 (DE) 10 2011 106 958.9

(51) Int. Cl. F02D 29/02; B60K 6/20

(52) U.S. Cl. 701/22; 180/65.28; 903/903

(57) ABSTRACT

A method for operating a vehicle is provided. The vehicle has a first motor and a second motor. The first motor is configured as an internal combustion engine and the second motor is configured as a drive motor of the vehicle, which operates free from combustion gas. The method includes determining a parameter that characterizes a possible reversing of the vehicle and determining whether a reversing of the vehicle is imminent based on the parameter. If it is determined that a reversing of the vehicle is imminent, the first motor is automatically switched off.

### CROSS-REFERENCE TO RELATED APPLICATION

This application claims priority to German Patent Application No. 10 2011 106 958.9, filed Jul. 8, 2011, which is incorporated herein by reference in its entirety.

### TECHNICAL FIELD

The technical field relates to a method for operating a vehicle, a vehicle, a computer program product, and a computer-readable medium.

### BACKGROUND

Known from DE 36 01 620 A1 is a motor vehicle having a transmission, which has a reverse gear which can be engaged by a shift lever, and having a heating and ventilation system, which includes a fan driven by an electric motor, which conveys air from the surroundings into the vehicle interior. In the motor vehicle, a switch with contacts is disposed in the circuit of the fan motor, which contacts are opened when reverse gear is engaged.

It is at least one object herein to provide a method for operating a vehicle, a vehicle, a computer program product, and a computer-readable medium, which enable improved user comfort for occupants of the vehicle.

### SUMMARY

A method for operating a vehicle, where the vehicle has a first motor and a second motor, is provided. The first motor is configured as an internal combustion engine and the second motor is configured as a drive motor of the vehicle, which operates free from combustion gas. The method comprises the following steps. A parameter which characterizes a possible reversing of the vehicle is determined In addition, it is determined whether a reversing of the vehicle is imminent based on the determined parameter. If it is determined that a reversing of the vehicle is imminent, the first motor is automatically switched off.

The method enables improved user comfort for occupants of the vehicle. This is accomplished by automatically switching off the first motor configured as an internal combustion engine if it is determined that a reversing of the vehicle is imminent. By this means, penetration of exhaust gases into a passenger compartment of the vehicle during a reversing of the vehicle can be avoided. This is particularly advantageous in automobiles and thereby in particular in convertibles.

In one embodiment the determination of the parameter includes a determination of an instantaneously engaged gear, in particular of a transmission of the vehicle. The first motor is automatically switched off if a reverse gear is engaged. The determination as to whether a reversing of the vehicle is imminent can thus be made in a simple manner.

In a further embodiment, the determination of the parameter includes a determination of the driving behavior of the vehicle. For example, positional data of the vehicle are determined and on the basis of the determined positional data, it is determined whether a reversing of the vehicle is imminent.

Furthermore, the determination of the parameter can include a determination of an instantaneous speed of the vehicle. In this embodiment, the determination as to whether a reversing of the vehicle is imminent is made on the basis of the determined instantaneous speed of the vehicle. For example, the first motor can be automatically disconnected if the instantaneous speed of the vehicle in the reversing direction exceeds a pre-determined threshold value.

In a further embodiment of the method, an opening state of a window of the vehicle is determined In this embodiment, the first motor is automatically switched off if it is determined that a reversing of the vehicle is imminent and if in addition the window is at least partially opened. The embodiment shown starts from the consideration here that the automatic switching off of the motor can be omitted if none of the vehicle windows is open without exhaust gases penetrating into the vehicle during a reversing as a result. A window of the vehicle is understood in particular here as a window of a roof opening system of the vehicle, for example, a sliding roof

In addition, in a vehicle configured as a convertible, an opening state of a roof or convertible top of the vehicle can be determined In this embodiment, the first motor is automatically switched off if it is determined that a reversing of the vehicle is imminent and if in addition, the roof or convertible top is additionally opened.

Furthermore, an operating state of an air-conditioning system of the vehicle can be determined The first motor is automatically switched off if it is determined that a reversing of the vehicle is imminent and if in addition the air conditioning system is operating, in particular if it is determined that the air-conditioning system is in a fresh-air mode. If the air-conditioning system is not operating, automatic switching off of the internal combustion engine can again be omitted without combustion gases thereby penetrating into the vehicle interior.

In a further embodiment, an opening state of a tailgate of the vehicle is determined. The first motor is automatically switched off if it is determined that a reversing of the vehicle is imminent and if in addition the tailgate is at least partially opened. In this embodiment the consideration is again taken as the starting point that the automatic switching off of the internal combustion engine when the tailgate is closed can be omitted without exhaust gases thereby entering into the passenger compartment.

The application further relates to a method for operating a vehicle, where the vehicle has a first motor and a second motor, where the first motor is configured as an internal combustion engine and where the second motor is configured as a drive motor of the vehicle, which operates free from combustion gas. The method comprises the following steps. An instantaneous position of the vehicle is determined In addition, it is determined whether the instantaneous position of the vehicle lies within an area predetermined by a user of the vehicle. If it is determined that the instantaneous position of the vehicle lies within an area predetermined by a user of the vehicle, the first motor is automatically switched off.

The embodiment again enables improved user comfort for occupants of the vehicle. In the embodiment shown, this is made possible by the first motor configured as an internal combustion engine being automatically switched off if it is determined that the instantaneous position of the vehicle lies within an area predetermined by a user of the vehicle. The embodiment shown thereby starts from the consideration that the user of the vehicle can thereby stipulate areas within which no combustion gases of the internal combustion engine should be released, for example an area of a garage or an entrance. This can be made possible in the situations by automatically switching off the first motor. In addition, the noise emission can advantageously be reduced when the internal combustion engine is switched off.

The area predetermined by a user of the vehicle is stipulated by means of an input into a navigation system, in particular into a navigation system of the vehicle. By this means, the predetermined area can be simply stipulated, for example, by determining the instantaneous position of the vehicle as an input and stipulating the predetermined area around this determined position. The predetermined area can, for example, correspond to a destination of a driving route of the vehicle entered into the navigation system.

In a second embodiment the second motor is configured as an electric motor. In this embodiment, the vehicle can in particular be configured as a vehicle having a parallel hybrid drive, that is both the first motor and the second motor are connected mechanically to a drive train of the vehicle. Furthermore, the vehicle can be configured as a vehicle fitted with a hybrid drive arranged in series, in which the internal combustion engine has no mechanical connection to the drive train. The last-mentioned embodiment is also designated as a vehicle having a range extender.

In a further embodiment after the first motor has been automatically switched off, a charging state of an energy storage apparatus for the second motor is determined The first motor is automatically switched on if the charging state falls below a predetermined threshold value. This ensures in a simple manner that the vehicle remains ready to drive even after the first motor has been automatically switched off.

The application additionally relates to a vehicle comprising a first motor, where the first motor is configured as an internal combustion engine. In addition, the vehicle comprises a second motor where the second motor is configured as a drive motor of the vehicle, which operates free from combustion gas. Furthermore, the vehicle comprises a first determination apparatus configured to determine a parameter which characterizes a possible reversing of the vehicle. Furthermore, the vehicle comprises a second determination apparatus configured to determine whether a reversing of the vehicle is imminent based on the determined parameter. Moreover, the vehicle comprises a switching-off apparatus configured to automatically switch off the first motor if it is determined that a reversing of the vehicle is imminent.

The application further relates to a vehicle comprising a first motor, where the first motor is configured as an internal combustion engine. In addition, the vehicle comprises a second motor, where the second motor is configured as a drive motor of the vehicle, which operates free from combustion gas. Furthermore, the vehicle has a first determination apparatus configured to determine an instantaneous position of the vehicle. In addition, the vehicle has a second determination apparatus configured to determine whether the instantaneous position of the vehicle lies within an area predetermined by a user of the vehicle. The vehicle further comprises a switching-off apparatus configured to automatically switch off the first motor if it is determined that the instantaneous position of the vehicle lies within an area predetermined by a user of the vehicle.

The vehicles according to the embodiments of the application have the advantages already mentioned in connection with the corresponding method according to the application, which will not be listed again at this point to avoid repetitions.

In the aforesaid embodiment, the vehicle is preferably a motor vehicle, in particular an automobile.

In addition, the application relates to a computer program product that, when it is executed on a processing unit of a vehicle, where the vehicle has a first motor and a second motor, where the first motor is configured as an internal combustion engine and where the second motor is configured as a drive motor of the vehicle, which operates free from combustion gas, instructs the processing unit to execute the following steps. The processing unit is instructed to determine a parameter which characterizes a possible reversing of the vehicle. In addition, the processing unit is instructed to determine whether a reversing of the vehicle is imminent based on the determined parameter. If it is determined that a reversing of the vehicle is imminent, the processing unit will automatically switch off the first motor.

The application further relates to a computer program product that, when it is executed on a processing unit of a vehicle, where the vehicle has a first motor and a second motor, where the first motor is configured as an internal combustion engine and wherein the second motor is configured as a drive motor of the vehicle, which operates free from combustion gas, instructs the processing unit to execute the following steps. The processing unit is instructed to determine an instantaneous position of the vehicle. In addition, the processing unit is instructed to determine whether the instantaneous position of the vehicle lies within an area predetermined by a user of the vehicle. If it is determined that the instantaneous position of the vehicle lies within the area predetermined by a user of the vehicle, the processing unit is instructed to automatically switch off the first motor.

The application further relates to a computer-readable medium on which a computer program product according to one of the embodiments is stored.

The computer program products and the computer-readable medium according to the embodiments of the application exhibit the advantages already mentioned in connection with the corresponding method according to the application which will not be listed again at this point to avoid repetitions.

### BRIEF DESCRIPTION OF THE DRAWINGS

The various embodiments will hereinafter be described in conjunction with the following drawing figures, wherein like numerals denote like elements, and wherein:

FIG. 1A shows a flow diagram of a method for operating a vehicle according to an exemplary embodiment;

FIG. 1B shows a flow diagram of a method for operating a vehicle according to an exemplary embodiment;

FIG. 2 shows a flow diagram of a method for operating a vehicle according to an exemplary embodiment;

FIG. 3 shows a flow diagram of a method for operating a vehicle according to an exemplary embodiment;

FIG. 4 shows a flow diagram of a method for operating a vehicle according to an exemplary embodiment;

FIG. 5 shows a flow diagram of a method for operating a vehicle according to an exemplary embodiment;

FIG. 6 shows a flow diagram of a method for operating a vehicle according to an exemplary embodiment;

FIG. 7 shows a vehicle according to an exemplary embodiment; and

FIG. 8 shows a vehicle according to an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

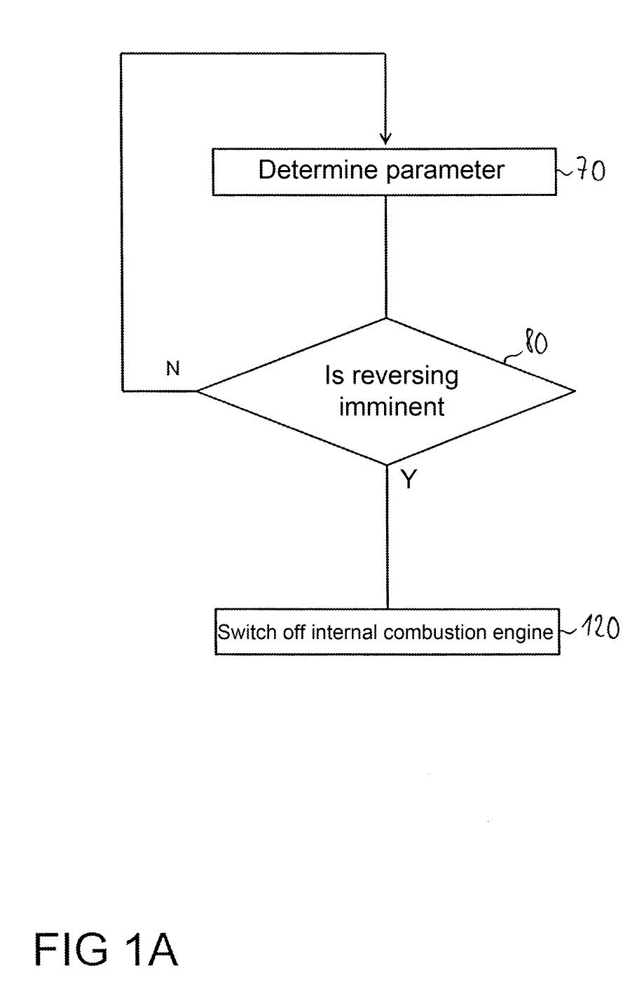

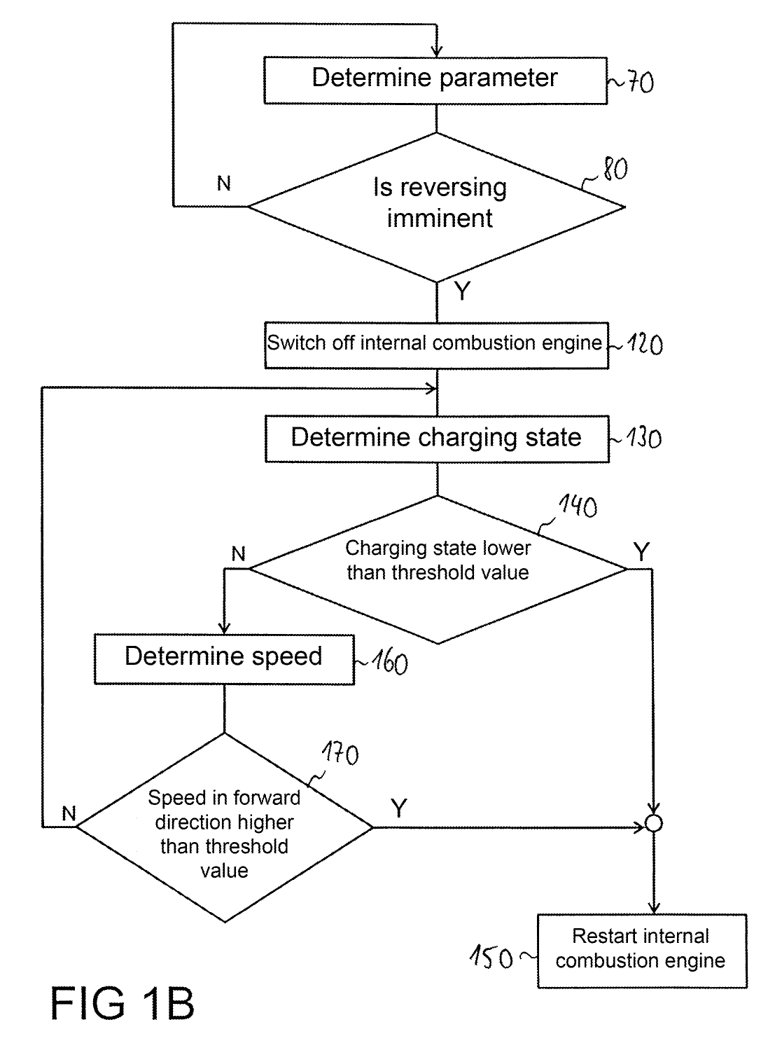

FIG. 1A shows a flow diagram of a method for operating a vehicle according to an exemplary embodiment. The vehicle comprises a first motor and a second motor, where the first motor is configured as an internal combustion engine and where the second motor is configured as a drive motor of the vehicle which operates free from combustion gas. The second motor is in this case configured, for example, as an electric motor. The vehicle is for example a motor vehicle, in particular an automobile.

In the embodiment shown, in a step 70 a parameter characterizing a possible reversing of the vehicle is determined The determination of the parameter can include a determination of an instantaneously engaged gear of a transmission of the vehicle. The determination of the parameter can include a determination of an instantaneous position and a determination of a driving behavior of the vehicle based on repeatedly determined positional data.

In a step 80 it is determined whether a reversing of the vehicle is imminent based on the determined parameter. In this case, it can be determined for example whether a reverse gear of the transmission is engaged. Furthermore, the determination can be made on the basis of the determined driving behavior.

If it is determined that a reversing of the vehicle is not imminent, steps 70 and 80 are executed repeatedly, for example, periodically at predetermined intervals.

If, on the other hand, it is determined in step 80 that a reversing of the vehicle is imminent, in the embodiment shown, in a step 120 the first motor is automatically switched off and therefore the internal combustion engine of the vehicle is automatically switched off. For example, the first motor is automatically switched off if a reverse gear is engaged.

FIG. 1B shows a flow diagram of a method for operating a vehicle according to another embodiment. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, a motor vehicle, in particular an automobile.

In a step 70, a parameter characterizing a possible reversing of the vehicle is determined and in a step 80 it is determined whether a reversing of the vehicle is imminent based on the determined parameter, corresponding to steps 70 and 80 of the embodiment shown in FIG. 1A.

If it is determined that a reversing of the vehicle is not imminent, steps 70 and 80 are carried out repeatedly.

If, on the other hand, it is determined that a reversing of the vehicle is imminent, the first motor is automatically switched off in a step 120.

In addition, in a step 130 a charging state of an energy storage apparatus for the second motor is determined For example, a charging state of a storage battery can be determined in the event that the second motor is configured as an electric motor.

In a step 140 it is determined whether the determined charging state of the energy storage apparatus falls below a predetermined threshold value. The predetermined threshold value can, for example, be fixedly set by a manufacturer of the vehicle. In a further embodiment, the predetermined threshold value can be fixed by a user of the vehicle. The predetermined threshold value in this case corresponds to a remaining range of the vehicle when this is driven solely by means of the second motor.

If the charging state falls below the predetermined threshold value, in a step 150 the first motor is automatically switched on again, i.e. the internal combustion engine is restarted.

If the charging state does not fall below the predetermined threshold value, in a step 160 an instantaneous speed of the vehicle is determined

In a step 170 it is determined whether the instantaneous speed of the vehicle in the forward direction exceeds a predetermined threshold value, for example 10 km/h.

If the speed in the forward direction does not exceed the predetermined threshold value, steps 130, 140 and optionally 160 and 170 are repeated. If, on the other hand, the speed in the forward direction exceeds the predetermined threshold value, the internal combustion engine is again restarted as shown in step 150. Here the consideration is taken as the starting point that exceeding the predetermined speed threshold value indicates that the driving maneuver associated with the reversing is completed. The threshold value test described advantageously avoids the first motor being automatically switched off and switched on again too frequently during driving forward and reversing in quick succession, for example in a parking gap.

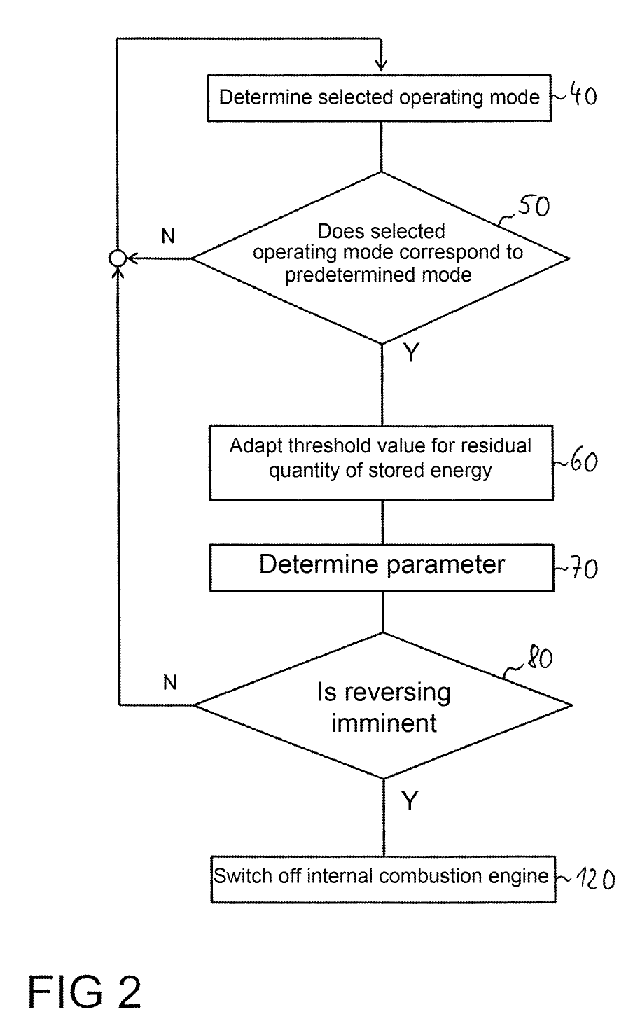

FIG. 2 shows a flow diagram of a method for operating a vehicle according to a further embodiment. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, again a motor vehicle, in particular an automobile.

In a step 40, in the embodiment shown, an instantaneously selected operating mode of the vehicle is determined For example, the vehicle can be operated in a first and a second operating mode, where the first mode allows the maximum possible range when the second motor is operated alone and where in the second mode, certain compromises have to be made with regard to the range in order to increase the comfort.

In a step 50, it is determined whether the instantaneously selected operating mode corresponds to a predetermined mode. For example, it can be determined whether the instantaneously selected operating mode corresponds to the second operating mode.

If the instantaneously selected operating mode does not correspond to the predetermined mode, steps 40 and 50 are repeated, for example, periodically in predetermined intervals.

If, on the other hand, it is determined in step 50 that the instantaneously selected operating mode corresponds to the predetermined mode, in a step 60 a threshold value is adapted for a minimum remaining residual amount of energy to be stored for the second motor in an energy storage apparatus. In the embodiment shown the threshold value is increased in this case so that the maximum range that can be covered when the second motor is operated alone is reduced. As a result, more energy remains for operation of the second motor in certain driving situations, in particular when reversing. In addition, in a step 70 a parameter characterizing a possible reversing of the vehicle is determined and in a step 80 it is determined whether a reversing of the vehicle is imminent based on the determined parameter, corresponding to steps 70 and 80 of the embodiment shown in FIG. 1A.

If it is determined that a reversing of the vehicle is not imminent, steps 40 and 50 as well as optionally 60, 70, and 80 are repeated.

If, on the other hand, it is determined that a reversing of the vehicle is imminent, in step 120 the first motor is automatically switched off.

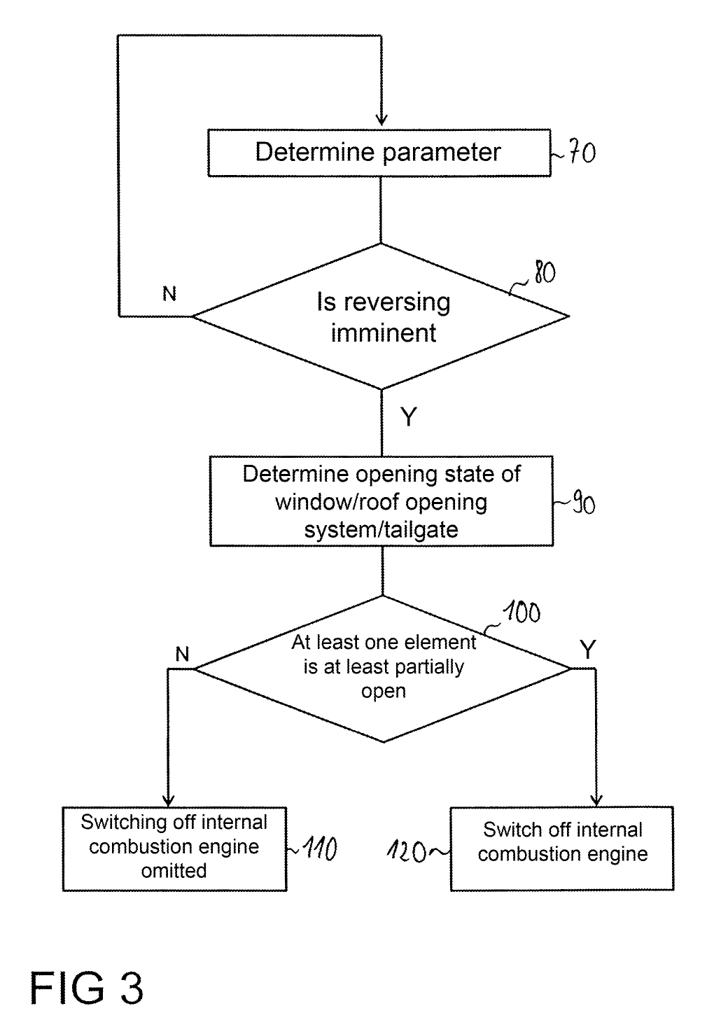

FIG. 3 shows a flow diagram of a method for operating a vehicle according to an embodiment. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, again a motor vehicle, in particular an automobile.

In a step 70, a parameter characterizing a possible reversing of the vehicle is determined and in a step 80 it is determined whether a reversing of the vehicle is imminent based on the determined parameter, corresponding to steps 70 and 80 of the embodiment shown in FIG. 1A. If it is determined that a reversing of the vehicle is not imminent, steps 70 and 80 are carried out repeatedly.

If, on the other hand, it is determined that a reversing of the vehicle is imminent, in the embodiment shown in a step 90 an opening state of a window of the vehicle is determined, where a window is understood in particular to be a window or a roof opening system of the vehicle and/or an opening state of a tailgate of the vehicle is determined. Consequently, an opening state of at least one element of the vehicle is determined, where the at least one element is selected from the group consisting of a window, a sliding roof, and a tailgate. In addition, in a vehicle configured as a convertible, an opening state of a vehicle or convertible top of the vehicle is determined

In a step 100 it is determined whether at least one of the elements is at least partially opened.

If none of the elements is at least partially opened, in the embodiment shown an automatic switching off of the internal combustion engine is omitted as shown in step 110.

If, on the other hand, at least one of the elements is at least partially opened, in a step 120 the first motor is automatically switched off, that is, the internal combustion engine is automatically switched off.

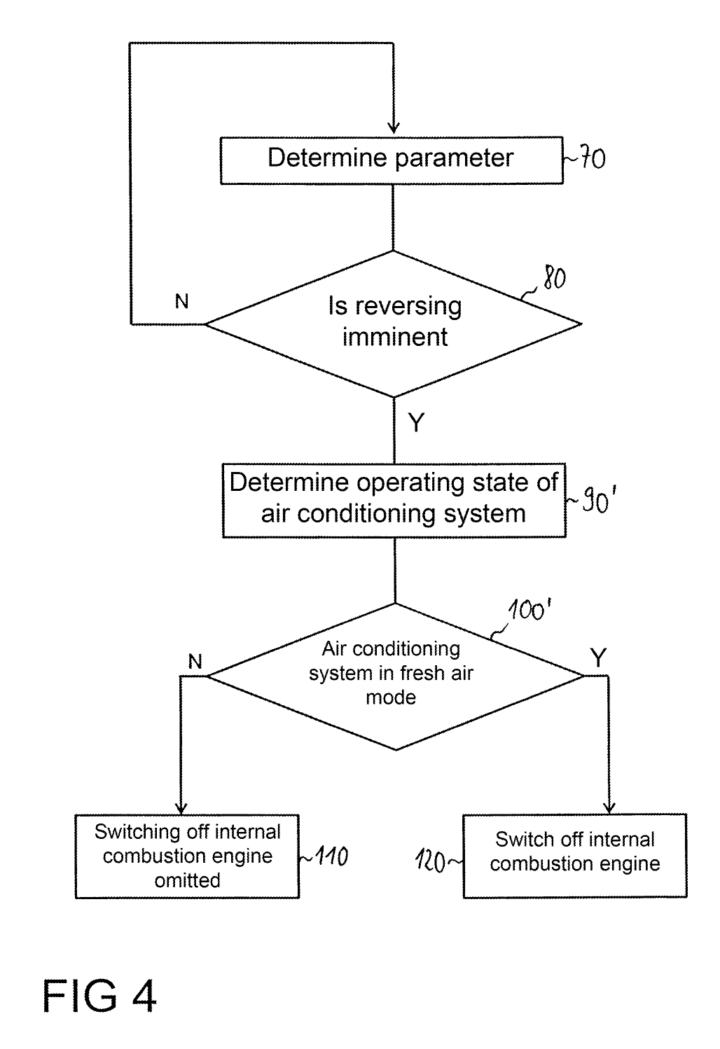

FIG. 4 shows a flow diagram of a method for operating a vehicle according to another embodiment. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, again a motor vehicle, in particular an automobile.

In a step 70, a parameter characterizing a possible reversing of the vehicle is determined and in a step 80 it is determined whether a reversing of the vehicle is imminent based on the determined parameter, corresponding to steps 70 and 80 of the embodiment shown in FIG. 1A.

If it is determined that a reversing of the vehicle is not imminent, steps 70 and 80 are carried out repeatedly.

If, on the other hand, it is determined that a reversing of the vehicle is imminent, in a step 90′ an operating state of an air conditioning system of the vehicle is determined

In a step 100′ in the embodiment shown it is determined whether the air conditioning system is in a fresh air mode in which air is guided from an outer area of the vehicle into the vehicle interior.

If the air conditioning system is not in fresh air mode, an automatic switching off of the internal combustion engine is omitted as shown by step 110.

If, on the other hand, the air conditioning system is in fresh air mode, that is air from an outer area of the vehicle is fed into the vehicle interior, in a step 120 the first motor is automatically switched off, that is, the internal combustion engine is automatically switched off.

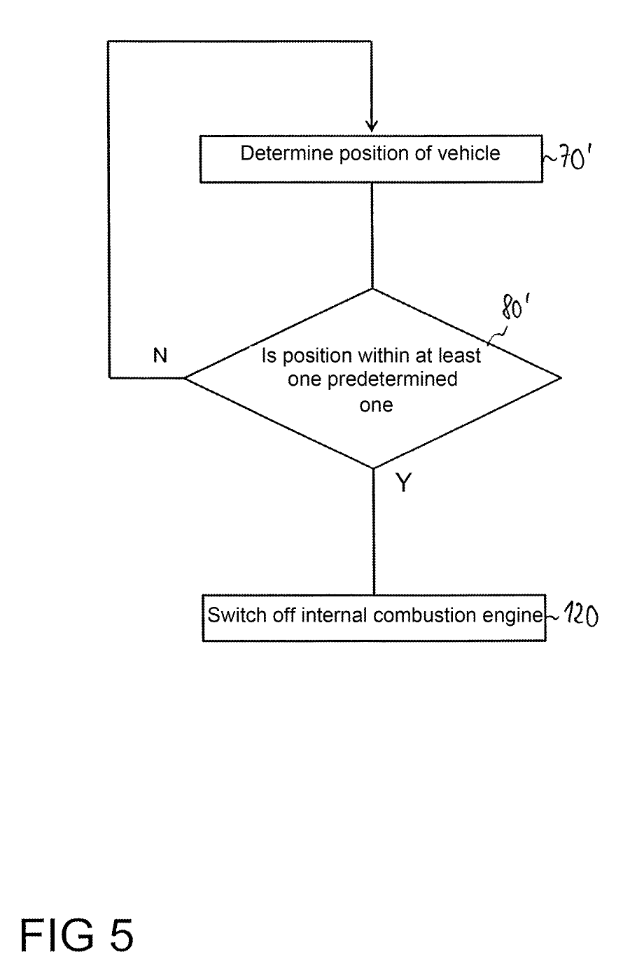

FIG. 5 shows a flow diagram of a method for operating a vehicle according to an embodiment of the application. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, again a motor vehicle, in particular an automobile.

In a step 70′, an instantaneous position of the vehicle is determined The determination of the instantaneous position of the vehicle is accomplished, for example, by means of a navigation system of the vehicle.

In a step 80′ it is determined whether the instantaneous position of the vehicle lies within an area predetermined by a user of the vehicle. The area predetermined by the user is in this case stipulated, for example, by means of an input into the navigation system.

If the instantaneous position of the vehicle does not lie within an area predetermined by a user of the vehicle, steps 70′ and 80′ are repeated, for example, periodically at predetermined intervals.

If on the other hand it is determined that the instantaneous position of the vehicle lies within the area predetermined by the user of the vehicle, in a step 120 the first motor is automatically switched off, that is, the internal combustion engine is automatically switched off.

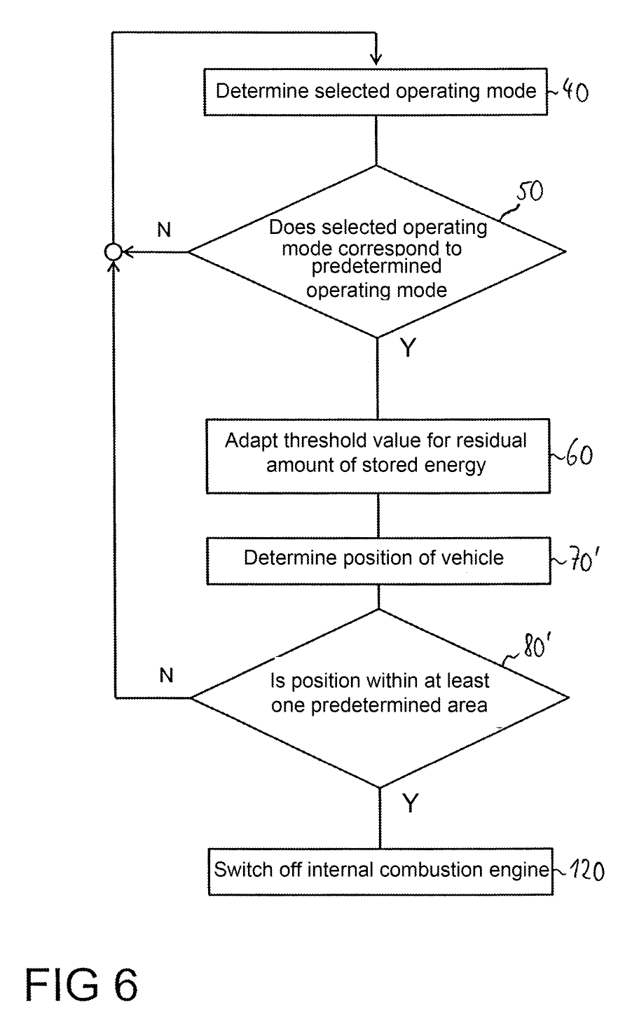

FIG. 6 shows a flow diagram of a method for operating a vehicle according to another embodiment of the application. The vehicle again comprises a first motor and a second motor, where the first motor is configured as an internal combustion engine and the second motor is configured as a vehicle drive motor which operates free from combustion gas. The second motor is configured, for example, as an electric motor. The vehicle is, for example, again a motor vehicle, in particular an automobile.

In a step 40 an instantaneously selected operating mode of the vehicle is determined and in a step 50 it is determined whether the instantaneously selected operating mode corresponds to a predetermined mode, according to steps 40 and 50 of the third embodiment shown in FIG. 2.

If the instantaneously selected operating mode does not correspond to the predetermined mode, steps 40 and 50 are repeated.

If, on the other hand, the instantaneously selected operating mode corresponds to the predetermined mode, in a step 60 a threshold value for a minimal residual amount of energy to be stored for an energy storage apparatus for the second motor is adapted, where the threshold value in the embodiment shown is increased, according to step 60 of the third embodiment shown in FIG. 2.

In a step 70′, an instantaneous position of the vehicle is determined and in a step 80′ it is determined whether the instantaneous position of the vehicle lies within an area predetermined by a user of the vehicle according to steps 70′ and 80′ of the embodiment shown in FIG. 5.

If the instantaneous position of the vehicle does not lie within an area predetermined by a user of the vehicle, steps 40 and 50 and optionally 60′, 70′ and 80′ are repeated. If on the other hand it is determined that the instantaneous position of the vehicle lies within the area predetermined by the user of the vehicle, in a step 120 the first motor is automatically switched off, that is, the internal combustion engine is automatically switched off.

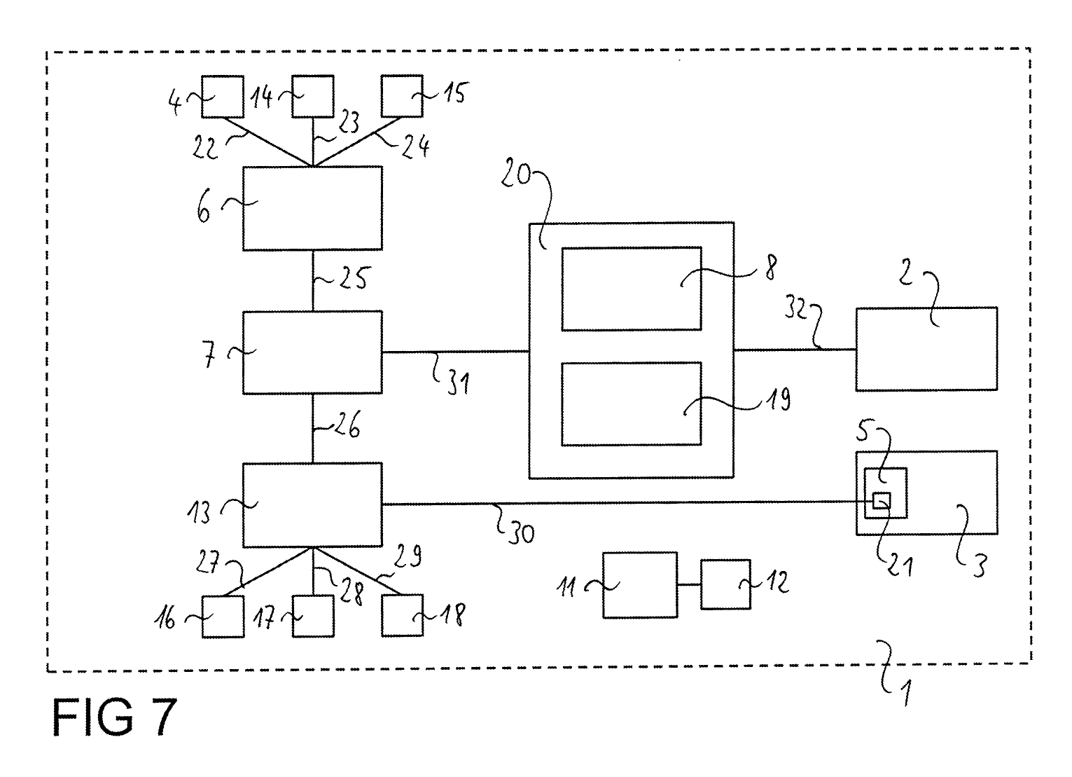

FIG. 7 shows a vehicle 1 according to the embodiment of FIG. 1. The vehicle 1 is, for example, a motor vehicle, in particular an automobile.

In this case, the vehicle 1 has a first motor 2, where the first motor 2 is configured as an internal combustion engine. In addition, the vehicle 1 has a second motor 3, where the second motor 3 is configured as a drive motor of the vehicle 1 operating free from combustion gas. For example, the second motor 3 is configured as an electric motor.

Furthermore, the vehicle 1 has a first determination apparatus 6, which is configured to determine a parameter characterizing a possible reversing of the vehicle 1. To this end, in the embodiment shown the first determination apparatus 6 is connected via a signal line 22 to a navigation system 4 of the vehicle 1. The driving behavior of the vehicle 1 can thus be determined on the basis of position data determined by a position determining apparatus of the navigation system 4. Furthermore, the first determination apparatus 6 is connected via a signal line 23 to a sensor 14, where the sensor 14 is configured to determine an instantaneously engaged gear of a transmission of the vehicle 1 not shown in detail. Furthermore, the first determination apparatus 6 is connected via a signal line 24 to a sensor 15, where the sensor 15 is configured to determine an instantaneous speed of the vehicle 1.

The vehicle 1 additionally has a second determination apparatus 7 which is configured to determine whether a reversing of the vehicle 1 is imminent based on the determined parameter. To this end, the second determination apparatus 7 is connected via a signal line 25 to the first determination apparatus 6.

In the embodiment shown the vehicle 1 also has a third determination apparatus 13. In the embodiment shown the third determination apparatus 13 is connected via a signal line 30 to a sensor 21, where the sensor 21 is configured to determine a charging state of an energy storage apparatus 5 of the second motor 3. Furthermore, the third determination apparatus 13 is connected via a signal line 27 to a sensor 16, where the sensor 16 is configured to determine an opening state of a window of the vehicle 1 not shown in detail. Furthermore, the third determination apparatus 13 is connected via a signal line 28 to a sensor 17, where the sensor 17 is configured to determine an opening state of a tailgate of the vehicle 1. In addition, the third determination apparatus 13 is connected via a signal line 29 to a sensor 18, where the sensor 18 is configured to determine an operating state of an air conditioning system of the vehicle 1 not shown in detail.

The third determination apparatus 13 is additionally connected via a signal line 26 to the second determination apparatus 7. The second determination apparatus 7 is in turn connected via a signal line 31 to a control unit 20 for the first motor 2. The control unit 20 has a switching-off apparatus 8 which is configured to automatically switch off the first motor 2. To this end, the control unit 20 is connected via a control and signal line 32 to the first motor 2.

In the embodiment shown, the first motor 2 is therefore automatically switched off if it is determined that a reversing of the vehicle 1 is imminent and in addition, at least one window and/or tailgate is at least partially opened and/or the air-conditioning system is operating. The first motor 2 is restarted by means of the starter device 19 if the charging state of the energy storage apparatus 5 for the second motor 3 falls below a predetermined threshold value and/or if the speed of the vehicle 1 in the forward direction exceeds a predetermined threshold value.

To this end, in the embodiment shown the vehicle 1 has a processing unit 11 and a computer-readable medium 12, where a computer program product is stored on the computer-readable medium 12, which, when executed on the processing unit 11, instructs the processing unit 11 to execute the steps specified in connection with the embodiments of the method, in particular the steps of the method according to FIGS. 1A to 4 by means of the specified elements. To this end, the processing unit 11 is connected directly or indirectly in a manner not shown in detail to the corresponding elements.

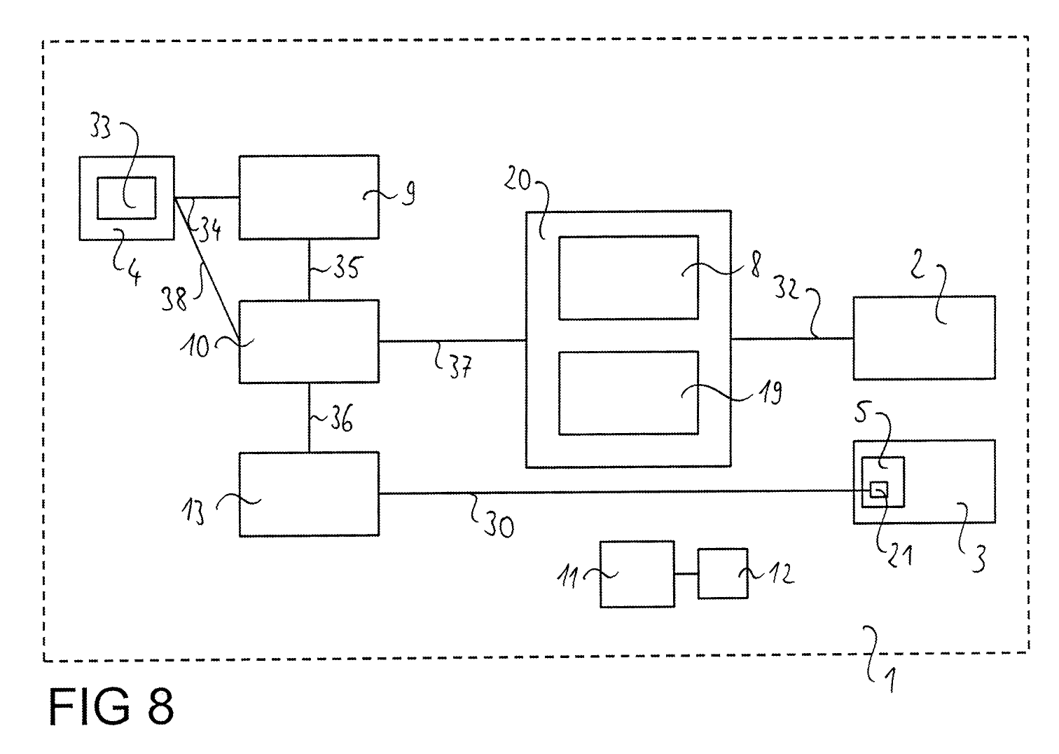

FIG. 8 shows a vehicle 1 according to a further embodiment of the application. Components having the same functions as in FIG. 7 are characterized with the same reference numbers and not explained again in the following. The vehicle 1 is, for example, again a motor vehicle, in particular an automobile.

The embodiment shown in FIG. 8 differs from the embodiment shown in FIG. 7 in that the vehicle 1 has a first determination apparatus 9 which is configured to determine an instantaneous position of the vehicle 1. To this end, the first determination apparatus 9 is connected via a signal line 34 to a navigation system 4 of the motor vehicle 1.

In the embodiment shown, the vehicle 1 also has a second determination apparatus 10, which is configured to determine whether the instantaneous position of the vehicle 1 lies within an area predetermined by a user of the vehicle 1. To this end, the second determination apparatus 10 is connected via a signal line 38 to the navigation system 4. The area predetermined by the user of the vehicle is stipulated in the embodiment shown by means of an input into the navigation system 4. To this end the navigation system 4 has a touchscreen 33.

In the embodiment shown, the first motor 2 is therefore automatically switched off by means of the switching off apparatus 8 if it is determined that the instantaneous position of the vehicle 1 lies within an area predetermined by a user of the vehicle 1. The first motor 2 is restarted by means of the starting apparatus 19 if the charging state of the energy storage apparatus 5 for the second motor 3 falls below a predetermined threshold value.

In the embodiment shown the vehicle 1 again has a processing unit 11 and a computer-readable medium 12, where a computer program product is stored on the computer-readable medium 12, which, when executed on the processing unit 11, instructs the processing unit 11 to execute the steps specified in connection with the embodiments of the method, in particular the steps of the method according to FIGS. 5 and 6 by means of the specified elements. To this end, the processing unit 11 is connected directly or indirectly in a manner not shown in detail to the corresponding elements.

In the method or the vehicles according to the embodiments shown, the consideration is thus taken as the starting point that hybrid vehicles or electric vehicles having range extenders, also designated as E-REV, are capable of being able to cover a certain distance without an operating internal combustion engine but start the engine on the basis of parameters such as, for example, the charging state of the battery or the vehicle speed. In this case, various operating modes are typically offered for a user of the vehicle, for example an economy mode with the greatest possible range where only the drive motor operating free from combustion gases is operating and a comfort mode, in which certain compromises are made in regard to the range in order to increase the comfort.

In methods according to the embodiments, the internal combustion engine is automatically switched off or deactivated as soon as reverse gear is activated. This makes it possible to drive backward without combustion or exhaust gases entering into the passenger compartment even if windows and/or a roof of the vehicle are opened. This is of particular interest for the occupants of convertibles, in particular for the driver, since it is not possible to close the roof or convertible top every time before a reversing.

In order to be able to provide the method, a certain small amount of electrical energy is retained in the energy storage apparatus in order to be able to cover a certain distance, for example 100 m, in reverse. It is thereby possible to link this to a comfort operating mode described above in order not to adversely affect the greatest possible range with electric drive in the economy mode. It is furthermore possible to link the automatic switching off with situations in which a window or a sliding roof or a convertible top are opened, that is the battery reserve for reversing is held in readiness only in these cases. If on the other hand all the windows and the sliding roof or convertible top are closed, on the other hand the maximum possible capacity of energy storage apparatus is used.

It is furthermore possible to link the automatic switching off with other parameters characterizing the air flow in the vehicle, depending on vehicle type and operating mode. For example, the internal combustion engine can also be automatically switched off during reversing if the interior ventilation is switched on or is above a predetermined threshold value and is not in circulating air mode. Furthermore, the internal combustion engine can also be automatically deactivated during reversing if a tailgate sensor determines that the tailgate is open when the vehicle is traveling, for example, when transporting a cumbersome load.

According to further embodiments, in particular the driver of the vehicle can input a delimited area in map data of a navigation system in which he prefers the internal combustion engine to be switched off For example, the emission of combustion gases and driving noise in front of his own house can be avoided by this means. For this purpose, the driver inputs once the area or the areas which are to be free from emissions. This is made possible in a simple manner for example by a function in the navigation menu, by which means a so-called emission-free zone can be input around the instantaneous position of the vehicle or around the destination input into the navigation system. The size of the zone can be predetermined, for example, a circle having a diameter of 50 m, or can be set by the driver of the motor vehicle. After setting these emission zones once, these are stored permanently in the vehicle.

If the vehicle enters into the vicinity of one of these emission-free zones, for example at a distance of 2 km from such a zone, a battery control unit ensures that sufficient energy is held in readiness in the energy storage apparatus in order to be able to switch off the internal combustion engine within the zone. If necessary the internal combustion engine is activated as long as the vehicle is outside the emission-free zone. If the vehicle drives into the emission-free zone, the internal combustion engine is automatically switched off and a purely electric drive is thus provided for the vehicle.

The internal combustion engine is restarted if the vehicle in the first-mentioned embodiments drives at a speed above a predetermined threshold value, for example, 10 km/h in the forward direction again. This indicates that the driving maneuver initiated with the reversing is completed. This setting prevents the motor being frequently switched off and on in situations in which the vehicle frequently moves forward and reverses, for example, in a parking space.

The internal combustion engine is also restarted in the embodiments shown if the charging state of the energy storage apparatus does not allow any further driving without an internal combustion engine.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating a vehicle, wherein the vehicle has a first motor and a second motor, wherein the first motor is configured as an internal combustion engine and wherein the second motor is configured as a drive motor of the vehicle, which operates free from combustion gas, and wherein the method comprises the steps of:
determining a parameter that characterizes a possible reversing of the vehicle;
determining whether a reversing of the vehicle is imminent based on the parameter; and
if it is determined that the reversing of the vehicle is imminent, automatically switching off the first motor.

2. The method according to claim 1, wherein determining the parameter includes determining if a reverse gear of the vehicle is engaged and wherein the first motor is automatically switched off if the reverse gear is engaged.

3. The method according to claim 1, wherein determining the parameter includes determining a driving behavior of the vehicle.

4. The method according to claim 1, further comprising determining an opening state of a window of the vehicle and wherein the first motor is automatically switched off if the window is at least partially opened.

5. The method according to claim 1, further comprising determining an operating state of an air-conditioning system of the vehicle and wherein the first motor is automatically switched off if the air-conditioning system is operating.

6. The method according to claim 1, further comprising determining an opening state of a tailgate of the vehicle and wherein the first motor is automatically switched off if the tailgate is at least partially opened.

7. Method for operating a vehicle, wherein the vehicle has a first motor and a second motor, wherein the first motor is configured as an internal combustion engine and wherein the second motor is configured as a drive motor of the vehicle, which operates free from combustion gas, and wherein the method comprises the steps of:
determining an instantaneous position of the vehicle;
determining whether the instantaneous position of the vehicle lies within an area predetermined by a user of the vehicle;
if it is determined that the instantaneous position of the vehicle lies within the area predetermined by the user of the vehicle, automatically switching off the first motor.

8. The method according to claim 7, wherein the area predetermined by the user of the vehicle is stipulated by an input into a navigation system.

9. The method according to claim 7, wherein the second motor is configured as an electric motor.

10. The method according to claim 7, wherein after the first motor has been automatically switched off, determining a charging state of an energy storage apparatus for the second motor and automatically switching on the first motor if the charging state falls below a predetermined threshold value.

11. A vehicle comprising:
a first motor, wherein the first motor is configured as an internal combustion engine;
a second motor, wherein the second motor is configured as a drive motor of the vehicle, which operates free from combustion gas;
a first determination apparatus configured to determine a parameter which characterizes a possible reversing of the vehicle;
a second determination apparatus configured to determine whether a reversing of the vehicle is imminent based on the parameter; and
a switching-off apparatus configured to automatically switch off the first motor if it is determined that the reversing of the vehicle is imminent.

12. A vehicle comprising:
a first motor, wherein the first motor is configured as an internal combustion engine;
a second motor, wherein the second motor is configured as a drive motor of the vehicle, which operates free from combustion gas;
a first determination apparatus configured to determine an instantaneous position of the vehicle;
a second determination apparatus configured to determine whether the instantaneous position of the vehicle lies within an area predetermined by a user of the vehicle; and
a switching-off apparatus configured to automatically switch off the first motor if it is determined that the instantaneous position of the vehicle lies within the area predetermined by the user of the vehicle.

13. A computer program product that, when it is executed on a processing unit of a vehicle, wherein the vehicle has a first motor and a second motor, wherein the first motor is configured as an internal combustion engine and wherein the second motor is configured as a drive motor of the vehicle, which operates free from combustion gas, instructs the processing unit to execute the following steps:
determine a parameter that characterizes a possible reversing of the vehicle;
determine whether a reversing of the vehicle is imminent based on the parameter; and
if it is determined that the reversing of the vehicle is imminent, automatically switch off the first motor.

14. Computer program product that, when it is executed on a processing unit of a vehicle, wherein the vehicle has a first motor and a second motor, wherein the first motor is configured as an internal combustion engine and wherein the second motor is configured as a drive motor of the vehicle, which operates free from combustion gas, instructs the processing unit to execute the following steps:
determine an instantaneous position of the vehicle;
determine whether the instantaneous position of the vehicle lies within an area predetermined by a user of the vehicle;
if it is determined that the instantaneous position of the vehicle lies within the area predetermined by the user of the vehicle, automatically switch off the first motor.
